(19) United States
(12) Patent Application Publication
(10) Pub. No.: US 2024/0154880 A1
(43) Pub. Date: May 9, 2024

(54) METHOD AND APPARATUS FOR QOE MEASUREMENT OF UE IN DUAL CONNECTIVITY IN A WIRELESS COMMUNICATION SYSTEM

(71) Applicant: Samsung Electronics Co., Ltd., Suwon-si (KR)

(72) Inventors: Seungbeom JEONG, Suwon-si (KR); Sangyeob JUNG, Suwon-si (KR)

(21) Appl. No.: 18/499,991

(22) Filed: Nov. 1, 2023

(30) Foreign Application Priority Data
Nov. 3, 2022 (KR) 10-2022-0145160

(51) Int. Cl. H04L 41/5009; H04W 24/06; H04W 76/15

(52) U.S. Cl. CPC H04L 41/5009; H04W 24/06; H04W 76/15

(57) ABSTRACT

The disclosure relates to a 5G or 6G communication system for supporting a higher data transmission rate. A method of UE comprises: receiving, from a base station, configuration information on a quality of experience (QoE) measurement, wherein the configuration information includes information indicating a signaling radio bearer (SRB) for transmitting a report of the QoE measurement; generating a QoE report by performing the QoE measurement based on the configuration information; and transmitting the QoE report via the SRB based on the information.

### CROSS-REFERENCE TO RELATED APPLICATION

This application is based on and claims priority under 35 U.S.C. § 119 to Korean Patent Application No. 10-2022-0145160, filed on Nov. 3, 2022, in the Korean Intellectual Property Office, the disclosure of which is herein incorporated by reference in its entirety.

### BACKGROUND

### 1. Field

The disclosure relates to the field of communications and to the operations of user equipments (UEs) and base stations. In particular, the disclosure relates to a method and apparatus for quality of experience (QoE) measurement of a UE in a dual connectivity in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosed embodiment intends to provide an apparatus and method that may effectively provide services in a wireless communication system.

According to an embodiment of the disclosure, a method performed by a terminal is provided. The method comprises: receiving, from a base station, configuration information on a quality of experience (QoE) measurement, wherein the configuration information includes information indicating a signaling radio bearer (SRB) for transmitting a report of the QoE measurement according to the configuration information; generating a QoE report by performing the QoE measurement based on the configuration information; and transmitting the QoE report via the SRB based on the information.

According to an embodiment of the disclosure, a method performed by a baes station is provided. The method comprises: transmitting, to a user equipment (UE), configuration information on a quality of experience (QoE) measurement, wherein the configuration information includes information indicating a signaling radio bearer (SRB) for receiving a report of the QoE measurement according to the configuration information; and receiving, from the UE via the SRB, a QoE report including the QoE measurement based on the configuration information.

According to an embodiment of the disclosure, a terminal is provided. The terminal comprises: a transceiver; and a controller coupled with the transceiver and configured to: receive, from a base station, configuration information on a quality of experience (QoE) measurement, wherein the configuration information includes information indicating a signaling radio bearer (SRB) for transmitting a report of the QoE measurement according to the configuration information, generate a QoE report by performing the QoE measurement based on the configuration information, and transmit the QoE report via the SRB based on the information.

According to an embodiment of the disclosure, a base station is provided. The base station comprises: a transceiver; and a controller coupled with the transceiver and configured to: transmit, to a user equipment (UE), configuration information on a quality of experience (QoE) measurement, wherein the configuration information includes information indicating a signaling radio bearer (SRB) for receiving a report of the QoE measurement according to the configuration information, and receive, from the UE via the SRB, a QoE report including the QoE measurement based on the configuration information.

The technical subjects pursued in the disclosure may not be limited to the above mentioned technical subjects, and other technical subjects which are not mentioned may be clearly understood, through the following descriptions, by those skilled in the art to which the disclosure pertains.

The disclosure provides an apparatus and method that may effectively provide services in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a structure of a next-generation mobile communication system according to an embodiment of the present disclosure;

FIG. 1B illustrates a radio access state transition in a next-generation mobile communication system according to an embodiment of the present disclosure;

FIG. 1C illustrates a flowchart of a procedure for configuring/reporting signaling-based QoE measurement according to an embodiment of the present disclosure;

FIG. 1D illustrates a flowchart of a procedure for configuring/reporting management-based QoE measurement according to an embodiment of the present disclosure;

FIG. 1E illustrates a flowchart of a procedure for configuring and reporting RAN (radio access network) visible QoE measurement according to an embodiment of the present disclosure;

FIG. 1F illustrates an SRB path in an SA situation according to an embodiment of the present disclosure;

FIG. 1G illustrates an SRB path in a DC situation according to an embodiment of the present disclosure;

FIG. 1H illustrates an internal structure of a UE according to an embodiment of the present disclosure; and

FIG. 1I illustrates a configuration of a base station according to an embodiment of the present disclosure.

### DETAILED DESCRIPTION

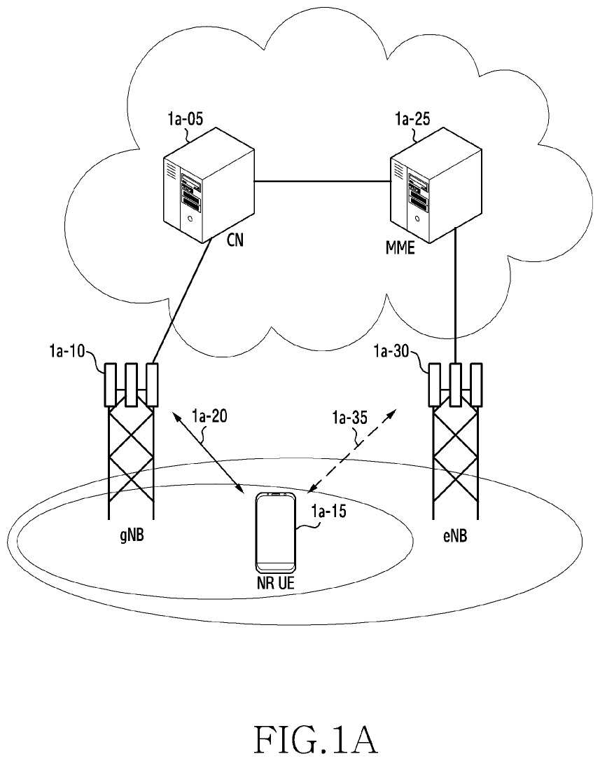

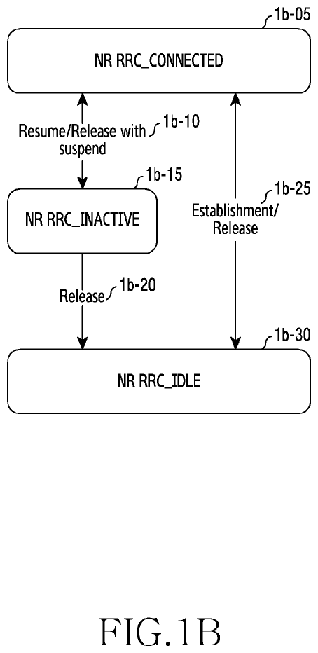

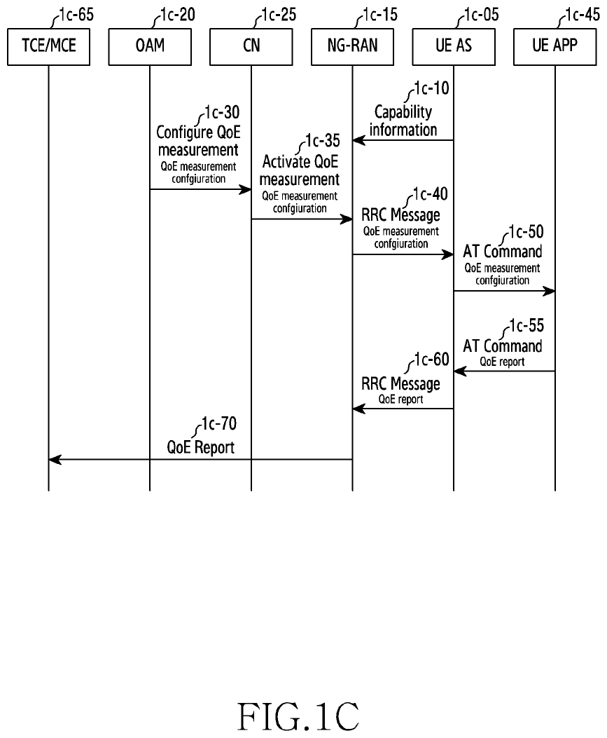

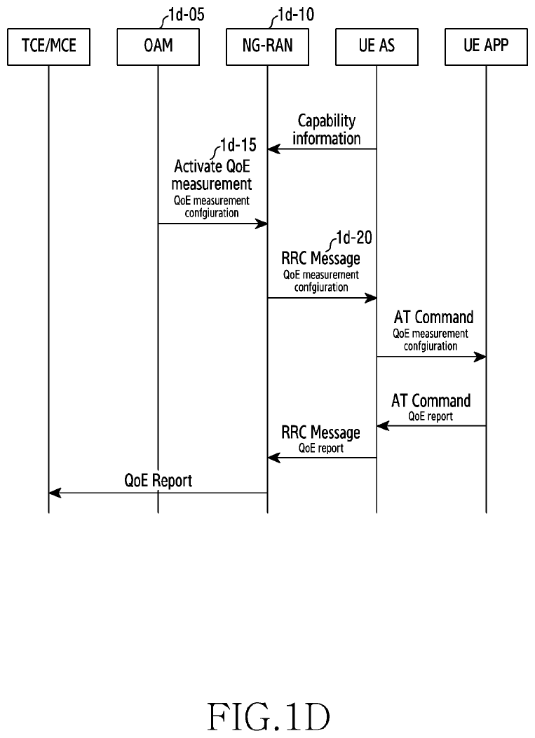

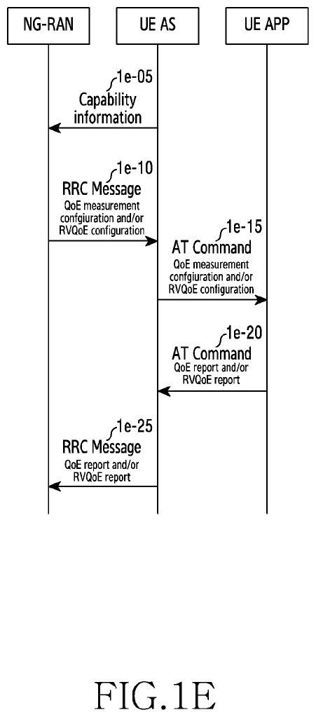

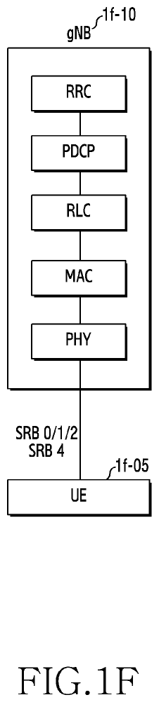

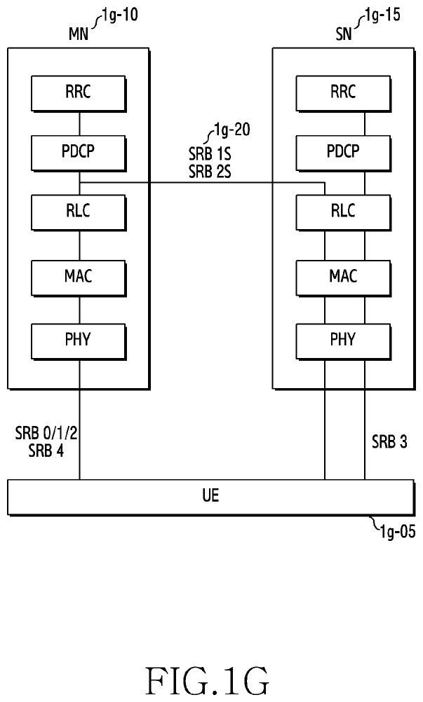

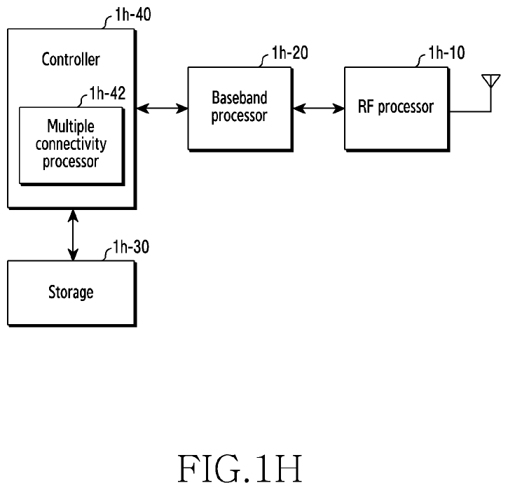

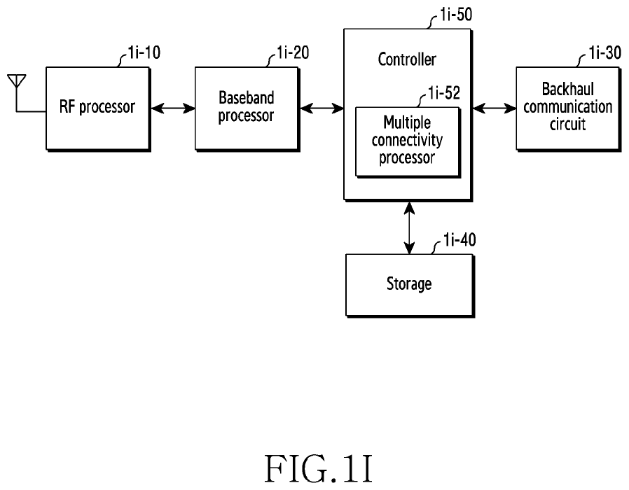

FIGS. 1A through 1I, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, exemplary embodiments of the disclosure will be described in detail with reference to the accompanying drawings. It should be noted that, in the drawings, the same or like elements are designated by the same or like reference signs as much as possible. Furthermore, a detailed description of known functions or configurations that may make the subject matter of the disclosure unclear will be omitted.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

In the following description, terms for identifying access nodes, terms referring to network entities or network functions (NFs), terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, some of terms and names defined in the 3rd generation partnership project long term evolution (3GPP LTE) or 3GPP new radio (3GPP NR) standards may be used for the sake of descriptive convenience. However, the disclosure is not limited by these terms and names, and may be applied in the same way to systems that conform other standards.

FIG. 1A illustrates a structure of a next-generation mobile communication system according to an embodiment of the present disclosure.

Referring to FIG. 1A, as illustrated, the radio access network of a wireless communication system (hereinafter referred to as the next-generation mobile communication system, new radio, NR, or 5G) may be composed of a next-generation base station (next generation Node B, hereinafter referred to as gNB) 1a-10 and a CN (new radio core network) 1a-05. A new radio user equipment (hereinafter referred to as NR UE or UE) 1a-15 may access an external network through a gNB 1a-10 and an CN 1a-05.

In FIG. 1A, the gNB may correspond to an evolved Node B (eNB) of the existing LTE system. The gNB is connected to the NR UE through a radio channel and may provide a service superior to that of the existing Node B. Because all user traffic is serviced through the shared channel in the next-generation mobile communication system, a device for scheduling by collecting state information such as a buffer state of the UEs, an available transmission power state, a channel state, etc. may be required, and the gNB 1a-10 may be responsible for this. One gNB may usually control multiple cells.

According to an embodiment of the disclosure, the next-generation mobile communication system may have a bandwidth greater than or equal to the existing maximum bandwidth in order to implement ultra-high-speed data transmission compared with existing LTE, and use additional beamforming technology by using orthogonal frequency division multiplexing (hereinafter, referred to as OFDM) as a radio access technology. In addition, according to an embodiment of the disclosure, the NR gNB 1a-10 may apply an adaptive modulation & coding (hereinafter, referred to as AMC) scheme for determining a modulation scheme and a channel coding rate according to the channel state of the UE. The CN 1a-05 (e.g., access and mobility management function (AMF) of the CN) performs functions such as mobility support, bearer configuration, QoS (quality of service) configuration, and the like.

The CN 1a-05 is a device in charge of various control functions as well as a mobility management function for the UE, and is connected to a plurality of base stations. In addition, the next-generation mobile communication system may be linked with the existing LTE system, and the AMF of the CN 1a-05 may be connected to the MME 1a-25 through a network interface. The Mobility Management Entity (MME) 1a-25 may be connected to the existing base station eNB 1a-30. The UE that supports LTE-NR Dual Connectivity may transmit and receive data while maintaining connectivity to not only the gNB but also the eNB (1a-35).

FIG. 1B illustrates a radio access state transition in a next-generation mobile communication system according to an embodiment of the present disclosure.

According to an embodiment of the disclosure, the next-generation mobile communication system may have three radio access states (RRC (radio resource control) states). The connected mode (RRC_CONNECTED) 1b-05 may be a radio access state in which the UE may transmit and receive data. The idle mode (RRC_IDLE) 1b-30 may be a radio access state in which the UE monitors whether paging is transmitted to the UE. The connected mode and idle mode are radio access states that also apply to existing LTE systems, and the detailed technologies applied to connected mode and idle mode may be the same as those of the existing LTE system. In the next-generation mobile communication system, a new inactive (RRC_INACTIVE) radio access state 1b-15 (hereinafter referred to as inactive mode) is defined. In the inactive mode, the UE context may be maintained in the base station and the UE and RAN-based paging may be supported.

The characteristics of the inactive mode are listed as follows. This is not limited to the examples below:
Cell re-selection mobility;
CN-NR RAN connection (both C/U-planes) has been established for UE;
The UE access stratum (AS) context is stored in at least one gNB and the UE;
Paging is initiated by NR RAN;
RAN-based notification area is managed by NR RAN; and/or
NR RAN knows the RAN-based notification area which the UE belongs to.

The UE in inactive mode may transition to connected mode or idle mode by using a specific procedure. According to the resume process, the UE switches from inactive mode to connected mode, and may be switched from connected mode to inactive mode by using the release procedure including suspend configuration information (1b-10). The procedure performed by the UE and the base station in the inactive mode may include a procedure for transmitting and receiving one or more RRC messages between the UE and the base station, and may consist of one or more steps. In addition, through the resume and release procedure, the UE may switch from inactive mode to idle mode (1b-20). Switching between the connected mode and idle mode follows the existing LTE technology. That is, switching between the inactive mode and idle mode may be performed through an establishment or release procedure (1b-25).

FIG. 1C illustrates a flowchart of a procedure for configuring/reporting signaling-based QoE measurement according to an embodiment of the present disclosure.

According to an embodiment of the disclosure, a UE access stratum (AS) 1c-05 may transmit information (e.g., qoe-Streaming-MeasReport, qoe-MTSI-MeasReport, qoe-VR-MeasReport, etc.) indicating whether the QoE measurement is supported for each service type (e.g., streaming, MTSI, VR) to the base station (or NG-RAN) 1c-15 through a UE capability message (e.g., UECapabilityInformati on) 1c-10.

According to an embodiment of the disclosure, before transmitting the UE capability message, the base station 1c-15 may transmit a message (e.g., UECapabilityEnquiry) regarding a request for the UE capability message. In addition, through the UE capability message, the UE may report to the base station whether the RAN visible QoE measurement is supported (e.g., ran-VisibleQoE-Streaming-MeasReport, ran-VisibleQoE-VR-MeasReport, etc.) for each service type (e.g., streaming, VR).

In addition, according to an embodiment, the UE may report whether the UL RRC segmentation for the QoE report message (e.g., ul-MeasurementReportAppLayer-Seg) is supported through the UE capability message. The UE capability message may include ASN.1 information of TABLE 1A and TABLE 1B, and related parameter descriptions as follows. This is not limited to the examples below.

TABLE 1A

| | | |
|---|---|---|
| QoE-Parameters-r17 ::= SEQUENCE { | | |
| qoe-Streaming-MeasReport-r17 | ENUMERATED | {supported} |
| OPTIONAL, | | |
| qoe-MTSI-MeasReport-r17 | ENUMERATED | {supported} |
| OPTIONAL, | | |
| qoe-VR-MeasReport-r17 | ENUMERATED | {supported} |
| OPTIONAL, | | |
| ran-VisibleQoE-Streaming-MeasReport-r17 | ENUMERATED | {supported} |
| OPTIONAL, | | |
| ran-VisibleQoE-VR-MeasReport-r17 | ENUMERATED | {supported} |
| OPTIONAL, | | |
| ul-MeasurementReportAppLayer-Seg-r17 | ENUMERATED | {supported} |
| OPTIONAL, | | |
| ... | | |
| } | | |

TABLE 1B
4.2.20 QoE measurement parameters

| | | | FDD- | FR1- |
|---|---|---|---|---|
| | | | TDD | FR2 |
| Definitions for parameters | Per | M | DIFF | DIFF |
| qoe-Streaming-MeasReport-rl7 | UE | No | No | No |
| Indicates whether the UE supports NR QoE Measurement | | | | |
| Collection for streaming services, see TS26.247. | | | | |
| qoe-MTSI-MeasReport-rl7 | UE | No | No | No |
| Indicates whether the UE supports NR QoE Measurement | | | | |
| Collection for MTSI services, see TS26.114. | | | | |
| qoe-VR-MeasReport-rl7 | UE | No | No | No |
| Indicates whether the UE supports NR QoE Measurement | | | | |
| Collection for VR services, see TS26.118. | | | | |
| ran-VisibleQoE-Streaming-MeasReport-rl7 | UE | No | No | No |
| Indicates whether the UE supports RAN visible QoE | | | | |
| Measurement Collection for streaming services. | | | | |
| ran-VisibleQoE-VR-MeasReport-rl7 | UE | No | No | No |
| Indicates whether the UE supports RAN visible QoE | | | | |
| Measurement Collection for VR services. | | | | |
| ul-MeasurementReportAppLayer-Seg-rl7 | UE | No | No | No |
| Indicates whether the UE supports RRC segmentation of the | | | | |
| MeasurementReportAppLayer message in UL, as specified in | | | | |
| TS38.331 | | | | |

Service types that may be supported in the LTE may include streaming and multimedia telephony service (MTSI) for IP multimedia subsystem (IMS), and in the NR, support for virtual reality (VR) is additionally defined in Re1-17, and multimedia broadcast multicast services (MBMS), extended reality (XR), etc. may be additionally supported in future releases. Of course, it is not limited to the above example.

According to an embodiment of the disclosure, operations administration and maintenance (OAM) 1c-20 provides QoE measurement configuration information to core network (CN) 1c-25 (1c-30). The CN that received the QoE measurement configuration information may activate the QoE measurement by transmitting the configuration information to the base station (1c-35). The base station that received the QoE measurement configuration information may deliver the QoE configuration information to the UE AS through an RRC message (e.g., RRCReconfiguration or RRCResume message) (1c-40). The RRC message may include an information element (IE) (e.g., APPLayerMeasConfig) as illustrated below, and the related parameter description may be as following and TABLE 2A and TABLE 2B.

```
TABLE 2A
-AppLayerMeasConfig
The IE AppLayerMeasConfig indicates configuration of application layer
measurements.
AppLayerMeasConfig information element
-- ASN1START
-- TAG-APPLAYERMEASCONFIG-START
AppLayerMeasConfig-r17 ::= SEQUENCE {
  measConfigAppLayerToAddModList-r17 SEQUENCE (SIZE
(1..maxNrofAppLayerMeas-r17)) OF MeasConfigAppLayer-r17 OPTIONAL, --
Need N
measConfigAppLayerToReleaseList-r17 SEQUENCE (SIZE
(1..maxNrofAppLayerMeas-r17)) OF MeasConfigAppLayerId-r17 OPTIONAL, --
Need N
  rrc-SegAllowed-r17 ENUMERATED {enabled} OPTIONAL,
-- Need R
  ...
}
MeasConfigAppLayer-r17 ::= SEQUENCE {
  measConfigAppLayerId-r17 MeasConfigAppLayerId-r17,
  measConfigAppLayerContainer-r17 OCTET STRING SIZE (1..8000))
OPTIONAL, -- Need N
  service Type-r17 ENUMERATED {streaming, mtsi, vr, spare5, spare4,
spare3, spare2, spare1} OPTIONAL, -- Need M
  pauseReporting BOOLEAN OPTIONAL, -- Need M
  transmissionOfSessionStartStop BOOLEAN OPTIONAL, --
Need M
  ran-VisibleParameters-r17 SetupRelease {RAN-VisibleParameters-r17}
OPTIONAL, -- Need M
  ...
}
RAN-VisibleParameters-r17 ::= SEQUENCE {
  ran-VisiblePeriodicity-r17 ENUMERATED {ms120, ms240, ms480, ms640,
ms1024} OPTIONAL, -- Need S
  numberOfBufferLevelEntries-r17 INTEGER (1..8)
OPTIONAL, -- Need R
  reportPlayoutDelayForMediaStartup-r17 BOOLEAN
OPTIONAL, -- Need M
  ...
}
-- TAG-APPLAYERMEASCONFIG-STOP
-- ASN1STOP
```

TABLE 2B
AppLayerMeasConfig field descriptions
measConfigAppLayerContainer
The field contains configuration of application layer measurements, see Annex L
(normative) in TS26.247, clause 16.5 in TS26.114 and TS26.118.
pauseReporting
The field indicates whether the transmission of measConfigAppLayerContainer is paused
or not.
ran-VisibleParameters
The field indicates whether RAN visible application layer measurement shall be reported
or not. The field is optionally present when serviceType is set to streaming or vr. Otherwise,
it is absent.
rrc-SegAllwed
The field indicates that RRC segmentation of MeasurementReportAppLayer is allowed. It
may be present only if the UE supports RRC segmentation of the
MeasurementReportAppLayer message in UL.
serviceType
Indicates the type of application layer measurement. Value streaming indicates Quality of
Experience Measurement Collection for streaming services (see TS26.247), value mtsi
indicates Quality of Experience Measurement Collection for MSTI (see TS26.114), value
vr indicates Quality of Experience Measurement Collection for VR services (see TS26.118).
The network always configures serviceType when application layer measurements are
initially configured and at fullConfig.
transmissionOfSessionStartStop
The field indicates whether the UE shall transmit indications when sessions in the
application layer start and stop. The UE transmits a session start indication upon
configuration of this field if a session already has started in the application layer.
RAN-VisibleParameters field descriptions
numberOfBufferLevelEntries
The field contains the maximum number of buffer level entries that can be reported for
RAN visible application layer measurements.
ran-VisiblePeriodicity
The field indicates the periodicity of RAN visible reporting. Value ms120 indicates
120 ms, value ms240 indicates 240 ms and so on.
reportPlayoutDelayForMediaStartup
The field indicates whether the UE shall report Playout Delay for Media Startup for RAN
visible application layer measurements.

The operation of the UE AS that receives the RRC message may be as follows in TABLE 2C.

TABLE 2C
5.3.5.13dApplication layer measurement configuration
The UE shall:
1> if measConfigAppLayerToReleaseList is included in
appLayerMeasConfig within RRCReconfiguration or RRCResume:
2> for each measConfigAppLayerId value included in the
measConfigAppLayerToReleaseList:
3> forward the measConfigAppLayerId and inform upper layers about
the release of the application layer measurement configuration including
any RAN visible application layer measurement configuration;
3> discard any application layer measurement report received from
upper layers;
3> consider itself not to be configured to send application layer
measurement report for the measConfigAppLayerId.
1> if measConfigAppLayerToAddModList is included in
appLayerMeasConfig within RRCReconfiguration or RRCResume:
2> for each measConfigAppLayerId value included in the
measConfigAppLayerToAddModList:
3> if measConfigAppLayerContainer is included for the corresponding
MeasConfigAppLayer configuration:
4> forward the measConfigAppLayerContainer, the
measConfigAppLayerId and the serviceType to upper layers considering
the service Type;
3> consider itself to be configured to send application layer
measurement report for the measConfigAppLayerId in accordance with
5.7.16;
3> forward the transmissionOfSessionStartStop, if configured, and
measConfigAppLayerId to upper layers considering the serviceType;
3> if ran-VisibleParameters is set to setup and the parameters have
been received:
4> forward the measConfigAppLayerId, the ran-VisiblePeriodicity, if
configured, the numberOfBufferLevelEntries, if configured, and the
reportPlayoutDelayForMediaStartup, if configured, to upper layers
considering the serviceType;
3> else if ran-VisibleParameters is set to release:
4> forward the measConfigAppLayerId and inform upper layers about
the release of the RAN visible application layer measurement
configuration;
3> if pauseReporting is set to true:
4> if at least one segment, but not all segments, of a segmented
MeasurementReportAppLayer message containing an application layer
measurement report associated with the measConfigAppLayerId has been
submitted to lower layers for transmission:
5> submit the remaining segments of the MeasurementReportAppLayer
message to lower layers for transmission;
4> suspend submitting application layer measurement report containers
to lower layers for the application layer measurement configuration
associated with the measConfigAppLayerId;
4> store any previously or subsequently received application layer
measurement report containers associated with the measConfigAppLayerId
for which no segment, or full message, has been submitted to lower layers
for transmission;
3> else if pauseReporting is set to false and if transmission of
application layer measurement report containers has previously been
suspended for the application layer measurement configuration associated
with the measConfigAppLayerId:
4> submit stored application layer measurement report containers to
lower layers, if any, for the application layer measurements configuration
associated with the measConfigAppLayerId;
4> resume submitting application layer measurement report containers
to lower layers for the application layer measurement configuration
associated with the measConfigAppLayerId;
NOTE 1:
The UE may discard reports when the memory reserved for storing application layer measurement reports becomes full.
NOTE 2:
The transmission of RAN visible application layer measurement reports is not paused when pauseReporting is set to true.

As described above, for QoE measurement configurations included in measConfigAppLayerToAddModList, the UE AS layer may deliver QoE measurement configuration information to the UE upper layer or UE application layer (UE APP) 1c-45 through a AT command (1c-50). Regarding the QoE measurement configurations included in measConfigAppLayerToAddReleaseList, the UE AS layer may send the AT command to delete the saved configuration information to the UE APP.

The UE APP (1c-45) may perform QoE measurement according to the received QoE measurement configuration information. In addition, the measurement results may be reported to the UE AS through AT commands according to the QoE measurement configuration information (1c-55). The UE AS that received the measurement results may report the same to the base station through an RRC Message (e.g., MeasurementReportAppLayer message) (1c-60). SRB4 may be used to report the QoE measurement results. The MeasurementReportAppLayer message may include ASN.1 information of table 3 and related parameter descriptions as follows in TABLE 3A.

```
  -MeasurementReportAppLayer
  The MeasurementReportAppLayer message is used for sending application
  layer measurement report.
  Signalling radio bearer: SRB4
  RLC-SAP: AM
  Logical channel: DCCH
  Direction: UE to Network
  MeasurementReportAppLayer message
  -- ASN1START
  -- TAG-MEASUREMENTREPORTAPPLAYER-START
  MeasurementReportAppLayer-r17 ::= SEQUENCE {
    criticalExtensions CHOICE {
      measurementReportAppLayer-r17 MeasurementReportAppLayer-r17-IEs,
      criticalExtensionsFuture SEQUENCE { }
    }
  }
  MeasurementReportAppLayer-r17-les ::= SEQUENCE {
    measurementReportAppLayerList-r17 MeasurementReportAppLayerList-
r17,
    lateNonCriticalExtension OCTET STRING OPTIONAL,
    nonCriticalExtension SEQUENCE{ } OPTIONAL
  }
  MeasurementReportAppLayerList-r17 ::= SEQUENCE (SIZE
(1..maxNrofAppLayerMeas-r17)) OF MeasReportAppLayer-r17
  MeasReportAppLayer-r17 ::= SEQUENCE {
    measConfigAppLayerId-r17 MeasConfigAppLayerId-r17,
    measReportAppLayerContainer-r17 OCTET STRING
OPTIONAL,
    appLayerSessionStatus-r17  ENUMERATED {started, stopped}
OPTIONAL,
    ran-VisibleMeasurements-r17 RAN-VisibleMeasurements-r17
OPTIONAL
  }
  RAN-VisibleMeasurements-r17 ::= SEQUENCE {
    applLayerBufferLevelList-r17 SEQUENCE (SIZE (1..8)) OF
AppLayerBufferLevel-r17 OPTIONAL,
    playoutDelayForMediaStartup-r17 INTEGER (0..30000)
OPTIONAL,
    pdu-SessionIdList-r17 SEQUENCE (SIZE (1..maxNrofPDU-Sessions-r17))
OF PDU-SessionID OPTIONAL,
    ...
  }
  AppLayerBufferLevel-r17 ::= INTEGER (0..30000)
-- TAG-MEASUREMENTREPORTAPPLAYER-STOP
-- ASN1STOP
```

TABLE 3B
MeasurementReportAppLayer field descriptions

appLayerBufferLevelList
The field indicates a list of application layer buffer levels, and each AppLayerBufferLevel
indicates the application layer buffer level in ms. Value 0 corresponds to 0 ms, value 1
corresponds to 10 ms, value 2 corresponds to 20 ms and so on. If the buffer level is larger
than the maximum value of 30000 (5 minutes), the UE reports 30000.
appLayerSessionStatus
Indicates that an application layer measurement session in the application layer starts or
ends.
playoutDelayForMediaStartup
Indicates the application layer playout delay for media start-up in ms. Value 0 corresponds
to 0 ms, value 1 corresponds to 1 ms, value 2 corresponds to 2 ms and so on. If the playout
delay for media start-up is larger than the maximum value of 30000 ms, the UE reports 30000.
measReportAppLayerContainer
The field contains application layer measurement report, see Annex L (normative) in TS
26.247 [68], clause 16.5 in TS 26.114 [69] and TS 26.118 [70].
pdu-SessionIdList
Contains the identity of the PDU session, or the identities of the PDU sessions, used for
application data flows subject to the RAN visible application layer measurements.

The specific procedure of the UE AS for reporting the RRC message may be as follows in TABLE 3C.

TABLE 3C
5.7.16 Application layer measurement reporting
5.7.16.1 General (see. FIG. 5.7.16.1-1: Application layer measurement
reporting)
The purpose of this procedure is to send application layer measurement
reports to the network.
5.7.16.2 Initiation
A UE capable of application layer measurement reporting in
RRC_CONNECTED may initiate the procedure when configured with
application layer measurement, i.e., when appLayerMeasConfig and SRB4
have been configured by the network.
Upon initiating the procedure, the UE shall:
1> for each measConfigAppLayerId:
2> if the UE AS has received application layer measurement report from
upper layers which has not been transmitted; and
2> if the application layer measurement reporting has not been
suspended for the measConfigAppLayerId associated with the application
layer measurement report according to clause 5.3.5.13d:
3> set the measReportAppLayerContainer in the
MeasurementReportAppLayer message to the received value in the
application layer measurement report;
2> set the measConfigAppLayerId in the MeasurementReportAppLayer
message to the value of the measConfigAppLayerId received together with
application layer measurement report information;
2> if session start or stop information has been received from upper
layers for the measConfigAppLayerId:
3> set the appLayerSessionStatus to the received value of the
application layer measurement information;
2> if RAN visible application layer measurement report has been
received from upper layers:
3> for each appLayerBufferLevel value in the received RAN visible
application layer measurement report:
4> set the appLayerBufferLevel values in the appLayerBufferLevelList to
the buffer level values received from the upper layer in the order with the
first appLayerBufferLevel value set to the newest received buffer level
value, the second appLayerBufferLevel value set to the second newest
received buffer level value, and so on until all the buffer level values
received from the upper layer have been assigned or the maximum number
of values have been set according to appLayerBufferLevel, if configured;
3> set the playoutDelayForMediaStartup to the received value in the
RAN visible application layer measurement report, if any;
3> for each PDU session ID value indicated in the received RAN visible
application layer measurement report, if any:
4> set the PDU-SessionID field in the pdu-SessionIdList to the indicated
PDU session ID value;
2> if the encoded RRC message is larger than the maximum supported
size of one PDCP SDU specified in TS 38.323:
3> if the RRC message segmentation is enabled based on the field rrc-
SegAllowed received in appLayerMeasConfig:
4> initiate the UL message segment transfer procedure as specified in
clause 5.7.7;
3> else:
4> discard the RRC message;
2> else:
3> submit the MeasurementReportAppLayer message to lower layers
for transmission upon which the procedure ends.

The base station may deliver the measurement result report to the final server (Trace Collection Entity (TCE) or Measurement Collection Entity (MCE), 1c-65) that collects the measurement report (1c-70).

FIG. 1D illustrates a flowchart of a procedure for configuring/reporting management-based QoE measurement according to an embodiment of the present disclosure.

The management-based QoE configuring/reporting procedure is substantially similar to the signaling-based procedure (FIG. 1C). Accordingly, in the disclosure, only the difference between the management-based method is described below, and other procedures and descriptions may correspond to the description of FIG. 1C.

According to an embodiment of the disclosure, in the management-based method, an OAM 1d-05 may directly transmit the QoE measurement configuration to a base station 1d-10 without going through a CN to activate the QoE measurement (1d-15). Upon receiving the QoE measurement configuration, the base station 1d-10 may search for a single UE or a plurality of UEs that meet various conditions (e.g., area scope, application layer capability, and service type). The base station may deliver the QoE measurement configuration to each of the UEs through an RRC message (e.g., RRCReconfiguration or RRCResume) (1d-20). Other procedures and message types may be regarded as the same as the description (signaling-based method) of FIG. 1C.

FIG. 1E illustrates a flowchart of a procedure for configuring and reporting RAN visible QoE measurement according to an embodiment of the present disclosure.

The QoE measurement described in FIGS. 1C and 1D is configured by the OAM, and the QoE measurement report generated accordingly is collected by TCE/MCE, so operators may use the QoE measurement report for network optimization. When the UE transmits a report on OAM-based QoE measurement to the base station and the base station receives the report, the base station may not be able to read or understand the measurement report.

The MeasurementReportAppLayer message includes a measurement report generated by the application layer of the UE in the measurementReportAppLayerContainer, but because the measurement report is stored in OCTEC STRING format, the measurement report may not be read or understood by the base station or the RRC layer of the base station. To solve this problem, RAN visible QoE (RVQoE) measurement is defined and introduced in 3GPP in order for the base station to read the QoE measurement report and use the same for network optimization such as radio resource management. The RVQoE measurement may be defined limited to specific service types (e.g., streaming, VR).

According to an embodiment, first, the UE may report to the base station whether the RVQoE measurement is supported by service type (e.g., streaming, VR) (1e-05). In this case, the UECapabilityInformation message may be used. For example, for streaming services, the UE may include or configure the ran-VisibleQoE-Streaming-MeasReport parameter in the UECapabilityInformation message, and for VR services, the UE may include or configure the ran-VisibleQoE-VR-MeasReport parameter. Through this, the base station may determine whether the UE supports the RVQoE measurement for each service type, and accordingly, the base station may generate an RVQoE measurement configuration and transmit the same to the UE (1e-10). In this case, the RVQoE measurement configuration may be delivered together with the OAM-based QoE measurement configuration. The RVQoE measurement configuration may be included in the RRCReconfiguration or RRCResume message. The base station may indicate the UE to setup or release the RVQoE measurement through setup or release of ran-VisibleParameters in AppLayerMeasConfig IE.

The ran-VisibleParameters may include RAN-VisibleParameters IE, through which the base station may provide some or all of the following parameters to the UE. This is not limited to the examples below:
RVQoE measurement report period (ran-VisiblePeriodicity): The UE AS or UE APP may transmit an RVQoE measurement report every measurement report period;
Number of buffer levels that may be reported (numberOfBufferLevelEntries): the UE AS or UE APP may include multiple buffer levels when reporting RVQoE measurements, and the number of buffer levels may be included less than the numberOfBufferLevelEntries value; and/or
Whether to report playout delay when media starts (reportPlayoutDelayForMediaStartup): when the reportPlayoutDelayForMediaStartup value is indicated as true, the UE AS or UE APP may transmit the playout delay by including the same in the RVQoE report when the media starts. When the reportPlayoutDelayForMediaStartup value is indicated as false, the UE may not include the playout delay when the media starts in the RVQoE report.

The AS layer of the UE may transmit this configuration information to the APP layer of the UE (1e-15). In this case, the RVQoE measurement configuration may be delivered together with the OAM-based QoE measurement configuration. The APP of the UE may perform QoE measurement based on the RVQoE measurement configuration information, generate an RVQoE measurement report, and transmit the report to the AS layer of the UE (1e-20).

According to an embodiment of the disclosure, the RVQoE measurement report may be delivered together with the OAM-based QoE measurement report. The AS layer of the UE that received the RVQoE measurement report may deliver the RVQoE measurement report to the base station (1e-25). In this case, the RVQoE measurement report may be delivered together with the OAM-based QoE measurement report.

In 1e-25, the RVQoE measurement report may be transmitted through the RAN-VisibleMeasurements IE in the MeasurementReportAppLayer message, and the RAN-VisibleMeasurements IE may include some or all of the following parameters. This is not limited to the examples below:
APP layer buffer level list (appLayerBufferLevelList): This may include multiple buffer levels measured by the UE APP. The number included by numberOfBufferLevelEntries during the RVQoE configuration may be limited;
Playout delay (playoutDelayForMediaStartup): This may indicate the playout delay in ms when the media starts. When reportPlayoutDelayForMediaStartup is configured to true during the RVQoE configuration, the UE may include the playoutDelayForMediaStartup parameter; and/or
PDU (protocol data unit) session ID list (pdu-SessionIdList): The pdu-SessionIdList may indicate the PDU session(s) used in the application data flow that is the target of RVQoE measurement. The base station may know for which PDU session(s) the RVQoE values (e.g., buffer level and playout delay) are measured through pdu-SessionIdList, and may optimize resource allocation and scheduling for the corresponding PDU session(s) accordingly.

The base station may read the RVQoE report and use the same to perform network optimization. For example, the QoE of a UE that is experiencing poor QoE for a specific service may be improved by allocating a larger amount of radio resources.

FIG. 1F illustrates an SRB path in an SA situation according to an embodiment of the preset disclosure.

The UE may be connected to the network in SA (Standalone) state. That is, the UE 1f-05 may communicate with one base station 1f-10. In this case, a signalling radio bearer (SRB) may be defined/used to transmit an RRC message or NAS message between the base station and the UE. In SA state, SRB0, SRB1, SRB2, and SRB4 may be configured/used. Among these, SRB4 may be used to transmit the UE's QoE measurement report message (or App layer measurement report message).

FIG. 1G illustrates an SRB path in a DC situation according to an embodiment of the present disclosure.

The UE may be connected to the network in DC (e.g., NR-DC) state. That is, the UE 1g-05 may communicate with two base stations 1g-10 and 1g-15 simultaneously. Each base station may be referred to as the master node (MN) 1g-10 and the secondary node (SN) 1g-15. In this case, the signalling radio bearer (SRB) may be defined/used to transmit an RRC message or NAS message between the base station and the UE. SRB0, SRB1, SRB2, and SRB4 may be configured/used for communication with the MN. Among these, SRB4 may be used to transmit the UE's QoE measurement report message (or App layer measurement report message). Among these, SRB1 and SRB2 may be configured as a split SRB 1g-20, and the split SRB may support communication between the UE and MN through the RRC/PDCP layer of the MN and the RLC/MAC/PHY layer of the SN. The base station may configure an SRB path for communication with the UE by using the split SRB. Whether to use the MN's RLC/MAC/PHY layer, the SN's RLC/MAC/PHY layer, or both may be configured. When both are used (that is, duplication), the reliability of message transmission may be increased through redundant transmission. On the other hand, SRB3 may be configured/used for communication between the UE and SN.

To support QoE measurement in NR-DC state, 3GPP Release 18 QoE includes the following information:
Specify to support for QoE in NR-DC, e.g., enable QoE reporting via SN;
Specify the QoE configuration, and measurement reporting over MN/SN for NR-DC architecture, and specify the QoE measurement reporting over the other DC leg in order to maintain the reporting continuity;

Note 1: The QoE measurements are not performed separately for each leg.
Support RAN-visible QoE and radio related measurement configuration and reporting in NR-DC scenarios;
Specify the QoE measurement continuity in mobility scenarios in NR-DC; and/or
Specify the alignment of QoE measurements (including legacy QoE and RAN visible QoE measurements) and radio related measurement in NR-DC.

Accordingly, the 3GPP RAN2 working group and the 3GPP RAN3 working group are conducting discussions and have reached the following agreement regarding QoE measurement reporting of NR-DC UEs:
Standards meeting RAN3 #117bis-e agreement;
In DC, the UE switches the reporting leg based on indication from network, FFS on implicit or explicit way,
Turn into an agreement the WA stating that, if QoE reports are received by the SN, the SN can forward the QoE reports to MCE directly,
The MN can receive RVQoE reports directly from the UE, and/or
The SN can receive RVQoE reports directly from the UE; and/or
Standards meeting RAN2 #119bis-e agreement.
Use SRB4 as baseline for Rel-18 QoE.

Accordingly, the UE may need to configure an SRB with the SN as well as the MN to transmit the QoE measurement report message. The UE may use SRB4 to transmit the QoE measurement report message to the MN (RRC layer of the MN). Alternatively, the UE may define/use the split SRB4 to transmit the QoE measurement report message to the MN (the MN's RRC layer). That is, the QoE measurement report message may be delivered to the PDCP/RRC layer of the MN through the PHY/MAC/RLC layer of the SN. Alternatively, the UE may use SRB3 to transmit the QoE measurement report message to the SN (RRC layer of the SN). According to an embodiment, the QoE measurement report may be a message that is used to optimize network operation but is not essential for network operation, so the QoE measurement report message may be a message with lower priority than the RRC message conventionally transmitted through SRB3. Accordingly, a new SRB (e.g., SRB5, lower priority than SRB3) may be defined/used for transmission of the QoE measurement report message to the SN (RRC layer of the SN). Like SRB3, SRB5 may connect the SN's RRC layer through the SN's PHY/MAC/RLC/PDCP layer.

According to an embodiment, to receive QoE configuration information from the MN (the MN's RRC layer), the UE may configure and use SRB1 (or Split SRB1). In order to receive QoE configuration information from the SN (RRC layer of SN), the UE may configure and use SRB3. Alternatively, the UE may receive QoE configuration information in the form of an SN message (including SN QoE configuration information) in the SRB1 message.

In accordance with the above-mentioned standards meeting agreement, a UE in the NR-DC state may receive indications for a reporting leg for QoE measurement reporting from the network. According to an embodiment, the reporting leg may refer to a path for QoE measurement reporting (path for whether to transmit to MN or SN).

According to an embodiment of the disclosure, when the UE receives QoE configurations (e.g., via appLayerMeasconfig within RRCReconfiguration or RRCResume) from the MN (or the MN's RRC layer) (or through an SRB used/defined in the MN's QoE configurations, e.g., SRB1 or Split SRB 1), the default reporting leg of the UE may be the MN. When the MN transmits the QoE configurations, a first indicator may be defined (e.g., in appLayerMeasconfig) to indicate the reporting leg to the SN.

According to an embodiment, when the first indicator indicating the reporting leg to the SN is configured to true or present, the UE may transmit a QoE measurement report to the SN (the RRC layer of the SN) and transmit the QoE measurement report through the SRB (e.g., SRB3, SRB 5) defined/used for QoE measurement report to the SN. Conversely, when the indicator is configured to false or absent, the UE may transmit the QoE measurement report to the default reporting leg, i.e., the MN (the RRC layer of the MN), and transmit the QoE measurement report through the SRB (e.g., SRB4, split SRB4) defined/used for QoE measurement reporting to the MN.

According to an embodiment of the disclosure, when the UE receives QoE configurations (e.g., via appLayerMeasconfig in RRCReconfiguration or RRCResume) from the SN (or the RRC layer of the SN) (or via an SRB used/defined in the QoE configurations of the SN, e.g., SRB3), the default reporting leg of the UE may be the SN. When the SN transmits the QoE configurations, a second indicator may be defined (e.g., in appLayerMeasconfig) to indicate the reporting leg to the MN.

According to an embodiment, when the second indicator indicating the reporting leg to the MN is configured to true or present, the UE may transmit a QoE measurement report to the MN (the RRC layer of the MN) and transmit the QoE measurement report through the SRB (e.g., SRB4) defined/used for QoE measurement report to the MN. Conversely, when the indicator is configured to false or absent, the UE may transmit the QoE measurement report to the default reporting leg, i.e., the SN (the RRC layer of the SN), and transmit the QoE measurement report through the SRB (e.g., SRB3, SRB5) defined/used for QoE measurement reporting to the SN.

According to an embodiment of the disclosure, one parameter (e.g., in appLayerMeasconfig) may be commonly defined for the first indicator and the second indicator. That is, the parameter sent by the MN (in appLayerMeasconfig) may refer to the first indicator, and the parameter sent by the SN (in appLayerMeasconfig) may refer to the second indicator.

According to an embodiment of the disclosure, regardless of which base station (the MN or SN) the UE receives QoE configuration information from, a third indicator (possible to indicate the MN or SB) may be defined within the QoE configuration information (e.g., appLayerMeasconfig). When the third indicator is configured to the MN, the UE may transmit a QoE measurement report to the MN (the MN's RRC layer), and may transmit the QoE measurement report through an SRB (e.g., SRB4) defined/used for the QoE measurement report to the MN. When the third indicator is configured to the SN, the UE may transmit a QoE measurement report to the SN (the SN's RRC layer), and may transmit the QoE measurement report through an SRB (e.g., SRB4) defined/used for the QoE measurement report to the SN.

According to an embodiment of the disclosure, the UE may have multiple (independent) QoE configurations, and accordingly, a QoE measurement configuration ID may be used to independently perform multiple QoE measurements and distinguish the QoE reporting information generated accordingly. For example, the base station may configure three pieces of QoE configuration information to the UE, and may indicate the first configuration information ID (e.g., measConfigAppLayerId=1), the second configuration information ID (e.g., measConfigAppLayerId=2), and the third configuration information ID (e.g., measConfigAppLayerId=3).

The UE may perform measurements through each QoE configuration information, map the QoE measurement report information generated accordingly with the corresponding QoE configuration ID, and report the mapped information to the base station. One QoE measurement report message may include indicating measConfigAppLayerId=1 and the corresponding measurement report result, may include indicating measConfigAppLayerId=2 and the corresponding measurement report result, and may include indicating measConfigAppLayerId=3 and the corresponding measurement report result. Of course, it is not limited to the above example.

According to an embodiment of the disclosure, the reporting leg may be configured for each QoE measurement configuration ID (e.g., measConfigAppLayerId). The base station, OAM, or CN may need to transmit measurement reports to other base stations for each QoE configuration. For example, the MN may need to include the RVQoE configuration generated by the MN in the measurement configuration information that is measConfigAppLayerId=1 and directly receive (without going through the MN) measurement reports on the RVQoE configuration. On the other hand, the SN may need to include the RVQoE configuration generated by the SN in the measurement configuration information that is measConfigAppLayerId=2 and directly receive (without going through the MN) measurement reports on the RVQoE configuration. Alternatively, the MN and SN may coordinate where to place the reporting leg for each QoE configuration. Alternatively, the OAM or CN may indicate where to place the reporting leg for each QoE configuration.

For this purpose, the configurations for the reporting leg (e.g., first indicator, second indicator, or third indicator) may be configured for each QoE measurement configuration ID (e.g., measConfigAppLayerId), and accordingly, the UE may select a different reporting leg for each QoE measurement configuration and transmit the QoE measurement report. For example, the UE may be indicated to transmit (via the first, second, or third directive corresponding to measConfigAppLayerId=1) the QoE measurement report corresponding to the configuration of measConfigAppLayerId=1 to the SN and may transmit the QoE measurement report of measConfigAppLayerId=1 to the SN (the RRC layer of the SN), and may transmit the QoE measurement report through an SRB (e.g., SRB4) defined/used for QoE measurement reporting to the SN. Simultaneously, the UE may be indicated to transmit (via the first, second, or third directive corresponding to measConfigAppLayerId=2) the QoE measurement report corresponding to the configuration of measConfigAppLayerId=2 to the MN and may transmit the QoE measurement report of measConfigAppLayerId=2 to the MN (the RRC layer of the MN), and may transmit the QoE measurement report through an SRB (e.g., SRB4) defined/used for QoE measurement reporting to the MN.

According to an embodiment of the disclosure, the UE may generate one QoE measurement report message (e.g., MeasurementReportAppLayer) by collecting only the QoE measurement reports for the multiple QoE configuration IDs indicated to be transmitted to the MN, and transmit the QoE measurement report through the SRB (e.g., SRB4) defined/used for QoE measurement report to the MN. In addition, the UE may generate another QoE measurement report message (e.g., MeasurementReportAppLayer) by collecting only the QoE measurement reports for the multiple QoE configuration IDs indicated to be transmitted to the SN, and transmit the QoE measurement report through the SRB (e.g., SRB3 or SRB5) defined/used for QoE measurement report to the SN.

According to an embodiment of the disclosure, the UE may select a reporting leg for QoE measurement reporting according to the SRB configuration received from the base station. If an SRB (e.g., SRB4) defined/used for QoE measurement reporting to the MN is configured, the UE may transmit the QoE measurement report to the MN (or only the QoE measurement report corresponding to measConfigAppLayerId that may be transmitted to the MN). If an SRB (e.g., SRB3 or SRB5) defined/used for QoE measurement reporting to the SN is configured, the UE may transmit the QoE measurement report to the SN (or only the QoE measurement report corresponding to measConfigAppLayerId that may be transmitted to the SN). If SRBs for both the MN and SN are configured, the UE may select and transmit an SRB in one of the two directions.

According to an embodiment of the disclosure, the UE may transmit the corresponding QoE measurement report to the base station (the MN or SN) that received QoE configurations. If the UE receives QoE measurement information from the MN (or if the QoE configurations are received through an SRB (e.g., SRB1) for the QoE configurations from the MN), the UE may transmit the corresponding measurement report to the MN. For example, if the receives the QoE configuration that is measConfigAppLayerId=1,3 from the MN, the UE may transmit a measurement report generated with measConfigAppLayerId=1,3 to the MN. Conversely, if the UE receives QoE measurement information from the SN (or if the QoE configurations are received through an SRB (e.g., SRB3) for the QoE configurations from the SN), the UE may transmit the corresponding measurement report to the SN. For example, if the receives the QoE configuration that is measConfigAppLayerId=2,4 from the SN, the UE may transmit a measurement report generated with measConfigAppLayerId=2,4 to the SN.

According to an embodiment of the disclosure, when the UE is indicated to report a QoE measurement to the MN, but is unable to transmit the QoE measurement report (e.g., when the corresponding SRB is not configured, in case of MCG failure, in case of MN overload (e.g., when pauseReporting from the MN is configured to true), etc.), the UE may transmit the QoE measurement report to the SN. In order to allow the operation of the UE (change of the UE's own reporting leg), an indicator (e.g., fourth indicator) from the base station may be included in the QoE configuration information. When the fourth indicator is included or configured to true, the UE may perform QoE measurement reporting to the SN even though the measurement reporting to the MN is configured. When the fourth indicator is omitted or configured to false, the UE cannot transmit, to the SN, the measurement reporting to the MN, and may either store the measurement reporting to the MN (for later transmission) or discard the measurement reporting to the MN (to save memory). When the UE performs the QoE measurement reporting to the SN even though the measurement reporting to the MN is configured, an indicator (fifth indicator) that the measurement report may be delivered to the MN may be defined/included in the QoE measurement report message. When the UE includes the fifth indicator or indicates the indicator as true, this may refer to that it is a QoE measurement reporting originally directed to the MN, and the SN may forward the corresponding report to the MN. When the UE omits the fifth indicator or indicates the indicator as false, this may refer to that it is a QoE measurement reporting originally directed to the SN, and the SN may not forward the corresponding report to the MN.

According to an embodiment of the disclosure, when the UE is indicated to report a QoE measurement to the SN, but is unable to transmit the QoE measurement report (e.g., when the corresponding SRB is not configured, in case of SCG failure, in case of SN overload (e.g., when pauseReporting from the SN is configured to true), etc.), the UE may transmit the QoE measurement report to the MN. In order to allow the operation of the UE (change of the UE's own reporting leg), an indicator (e.g., sixth indicator) from the base station may be included in the QoE configuration information. When the sixth indicator is included or configured to true, the UE may perform QoE measurement reporting to the MN even though the measurement reporting to the SN is configured. When the sixth indicator is omitted or configured to false, the UE cannot transmit, to the MN, the measurement reporting to the SN, and may either store the measurement reporting to the SN (for later transmission) or discard the measurement reporting to the SN (to save memory).

When the UE performs the QoE measurement reporting to the MN even though the measurement reporting to the SN is configured, an indicator (seventh indicator) that the measurement report may be delivered to the SN may be defined/included in the QoE measurement report message. When the UE includes the seventh indicator or indicates the indicator as true, this may refer to that it is a QoE measurement reporting originally directed to the SN, and the MN may forward the corresponding report to the SN. When the UE omits the seventh indicator or indicates the indicates as false, this may refer to that it is a QoE measurement reporting originally directed to the MN, and the MN may not forward the corresponding report to the SN.

In an embodiment of the disclosure, the fourth indicator and the sixth indicator may be defined as one common parameter (i.e., an indicator that allows QoE measurement reporting to a leg different from the configured leg).

In an embodiment of the disclosure, the fifth indicator and the seventh indicator may be defined as one common parameter (i.e., a parameter indicating that the QoE measurement report is directed to the leg opposite to the received base station).

According to an embodiment of the disclosure, when the UE receives the conventional pauseResume indicator as true from the MN (or through an SRB (e.g., SRB1) for QoE configuration from the MN), the UE may perform QoE measurement reporting to the SN or through an SRB (e.g., SRB3, or SRB5) to the SN. When the UE has never received or configured the pauseResume indicator as false from the MN (or via SRB (e.g., SRB1) for QoE configuration from the MN), the UE may perform QoE measurement reporting to the MN or through an SRB (e.g., SRB4) to the MN. This embodiment has the advantage of recycling conventional indicators.

According to an embodiment of the disclosure, when the UE receives the conventional pauseResume indicator as true from the SN (or through an SRB (e.g., SRB3) for QoE configuration from the SN), the UE may perform QoE measurement reporting to the MN or through an SRB (e.g., SRB3, or SRB5) to the MN. When the UE has never received or configured the pauseResume indicator as false from the SN (or via SRB (e.g., SRB1) for QoE configuration from the MN), the UE may perform QoE measurement reporting to the SN or through an SRB (e.g., SRB4) to the SN. This embodiment has the advantage of recycling conventional indicators.

According to an embodiment of the disclosure, an indicator (eighth indicator) indicating whether the UE supports QoE measurement (and/or configuration, and/or reporting) in NR-DC may be defined in the UE capability message (e.g., 1c-10). If the UE supports the QoE measurement (and/or configuration, and/or reporting) in NR-DC, the eighth indicator may be included in the UE capability message or configured to true. Conversely, if the UE does not support the QoE measurement (and/or configuration, and/or reporting) in NR-DC, the eighth indicator may be omitted in the UE capability message or configured to false.

According to an embodiment of the disclosure, an indicator (ninth indicator) indicating whether the UE supports changing the reporting leg for QoE measurement in NR-DC may be defined in the UE capability message (e.g., 1c-10). If the UE supports changing the reporting leg in NR-DC, the ninth indicator may be included in the UE capability message or configured to true. Conversely, if the UE does not support changing the reporting leg in NR-DC, the ninth indicator may be omitted in the UE capability message or configured to false.

Although the embodiments of the disclosure are written assuming NR-DC, they may be applied to various types of DC situations by using the same method.

FIG. 1H illustrates an internal structure of a UE according to an embodiment of the present disclosure.

Referring to FIG. 1H, the UE includes a radio frequency (RF) processor 1h-10, a baseband processor 1h-20, a storage 1h-30, and a controller 1h-40. Of course, it is not limited to the above example, and the UE may include more or fewer configurations than those illustrated in FIG. 1H.

The RF processor 1h-10 performs a function for transmitting and receiving a signal through a radio channel, such as band conversion and amplification of a signal. That is, the RF processor 1h-10 up-converts a baseband signal provided from the baseband processor 1h-20 into an RF band signal, transmits the RF band signal through an antenna, and down-converts the RF band signal received through the antenna to the baseband signal. For example, the RF processor 1h-10 may include a transmission filter, a reception filter, an amplifier, a mixer, an oscillator, a digital to analog converter (DAC), an analog to digital converter (ADC), etc. In the diagram, only one antenna is illustrated, but the UE may include a plurality of antennas. In addition, the RF processor 1h-10 may include a plurality of RF chains. Furthermore, the RF processor 1h-10 may perform beamforming. For the beamforming, the RF processor 1h-10 may adjust the phase and magnitude of each of signals transmitted and received through a plurality of antennas or antenna elements. In addition, the RF processor may perform MIMO, and may receive multiple layers when performing the MIMO operation.

The baseband processor 1h-20 may perform a function of converting between a baseband signal and a bit stream according to a physical layer standard of the system. For example, when transmitting data, the baseband processor 1h-20 may generate complex symbols by encoding and modulating a transmitted bit stream. In addition, when receiving data, the baseband processor 1h-20 may restore a received bit stream by demodulating and decoding the baseband signal provided from the RF processor 1h-10. For example, in the case of following an orthogonal frequency division multiplexing (OFDM) scheme, when transmitting data, the baseband processor 1h-20 may generate complex symbols by encoding and modulating a transmitted bit stream, map the complex symbols to subcarriers, and then configure OFDM symbols through an inverse fast Fourier transform (IFFT) operation and cyclic prefix (CP) insertion. In addition, when receiving data, the baseband processor 1h-20 divides the baseband signal provided from the RF processor 1h-10 into OFDM symbol units, restores signals mapped to subcarriers through a fast Fourier transform (FFT) operation, and then restores a received bit stream through demodulation and decoding.

The baseband processor 1h-20 and the RF processor 1h-10 transmits and receives signals as described above. Accordingly, the baseband processor 1h-20 and the RF processor 1h-10 may be referred to as a transmitter, a receiver, a transceiver, or a communicator. Furthermore, at least one of the baseband processor 1h-20 and the RF processor 1h-10 may include a plurality of communication modules to support a plurality of different radio access technologies. In addition, at least one of the baseband processor 1h-20 and the RF processor 1h-10 may include different communication modules to process signals of different frequency bands. For example, the different radio access technologies may include a wireless LAN (e.g., IEEE 802.11), a cellular network (e.g., LTE), or the like. In addition, the different frequency bands may include a super high frequency (SHF) (e.g., 2.NRHz, NRHz) band and a millimeter wave (e.g., 60 GHz) band.

The storage 1h-30 stores data such as a basic program, an application program, and configuration information for the operation of the UE. In particular, the storage 1h-30 may store information related to a second access node performing wireless communication by using the second radio access technology. In addition, the storage 1h-30 may provide stored data according to the request of the controller 1h-40. The storage 1h-30 may store a program for performing the above-described method for measuring QoE of a dual access UE.

The controller 1h-40 controls overall operations of the UE. For example, the controller 1h-40 transmits and receives signals through the baseband processor 1h-20 and the RF processor 1h-10. In addition, the controller 1h-40 writes data in the storage 1h-40 and reads the data. To this end, the controller 1h-40 may include at least one processor. For example, the controller 1h-40 may include a communication processor (CP) that controls for communication and an application processor (AP) that controls an upper layer such as an application program. In addition, according to an embodiment of the disclosure, the controller 1h-40 may include a multiple connection processor 1h-42 that performs processing to operate in a multiple connection mode. The controller 1h-40 may control the overall operations of the UE to perform the method related to QoE measurement of the dual access UE described above.

FIG. 1I illustrates a configuration of a base station according to an embodiment of the present disclosure.

As illustrated in FIG. 1I, the base station includes a radio frequency (RF) processor 1i-10, a baseband processor 1i-20, a backhaul communication circuit 1i-30, a storage 1i-40, and a controller 1i-50. Of course, it is not limited to the above example, and the base station may include more or fewer configurations than those illustrated in FIG. 1I.

The RF processor 1i-10 performs a function for transmitting and receiving a signal through a radio channel, such as band conversion and amplification of a signal. That is, the RF processor 1i-10 up-converts a baseband signal provided from the baseband processor 1i-20 into an RF band signal, transmits the RF band signal through an antenna, and down-converts the RF band signal received through the antenna to the baseband signal. For example, the RF processor 1i-10 may include a transmission filter, a reception filter, an amplifier, a mixer, an oscillator, a digital to analog converter (DAC), an analog to digital converter (ADC), etc. In the diagram, only one antenna is illustrated, but the base station may include a plurality of antennas. In addition, the RF processor 1i-10 may include a plurality of RF chains. Furthermore, the RF processor 1i-10 may perform beamforming. For the beamforming, the RF processor 1i-10 may adjust the phase and magnitude of each of signals transmitted and received through a plurality of antennas or antenna elements. The RF processor may perform a downlink MIMO operation by transmitting one or more layers.

The baseband processor 1i-20 may perform a function of converting between a baseband signal and a bit stream according to a physical layer standard of the system. For example, when transmitting data, the baseband processor 1i-20 may generate complex symbols by encoding and modulating a transmitted bit stream. In addition, when receiving data, the baseband processor 1i-20 may restore a received bit stream by demodulating and decoding the baseband signal provided from the RF processor 1h-10. For example, in the case of following an orthogonal frequency division multiplexing (OFDM) scheme, when transmitting data, the baseband processor 1i-20 may generate complex symbols by encoding and modulating a transmitted bit stream, map the complex symbols to subcarriers, and then configure OFDM symbols through an inverse fast Fourier transform (IFFT) operation and cyclic prefix (CP) insertion. In addition, when receiving data, the baseband processor 1h-20 may divide the baseband signal provided from the RF processor 1i-10 into OFDM symbol units, restore signals mapped to subcarriers through a fast Fourier transform (FFT) operation, and then restore a received bit stream through demodulation and decoding. The baseband processor 1i-20 and the RF processor 1i-10 may transmit and receive signals as described above. Accordingly, the baseband processor 1h-20 and the RF processor 1i-10 may be referred to as a transmitter, a receiver, a transceiver, or a communicator.

The backhaul communication circuit 1i-30 may provide an interface for performing communication with other nodes in the network. That is, the backhaul communication circuit 1i-30 may convert a bit stream transmitted from the main base station to another node, for example, an auxiliary base station, a core network, or the like, into a physical signal, and convert a physical signal received from the other node into a bit stream.

The storage 1i-40 may store data such as a basic program, an application program, and configuration information for the operation of the base station. In particular, the storage 1i-40 may store information on the bearer allocated to the accessed UE, measurement results reported from the accessed UE, etc. In addition, the storage 1i-40 may store information that serves as a criterion for determining whether to provide multiple accesses to the UE or to suspend the multiple accesses. In addition, the storage 1i-40 may provide stored data according to the request of the controller 1i-50. The storage 1i-40 may store a program for performing the above-described method for measuring QoE of a dual access UE.

The controller 1i-50 controls overall operations of the base station. For example, the controller 1i-50 may transmit and receive signals through the baseband processor 1i-20 and the RF processor 1i-10. In addition, the controller 1i-50 writes data in the storage 1i-40 and reads the data. To this end, the controller 1i-50 may include at least one processor. In addition, according to an embodiment of the disclosure, the controller 1i-50 may include a multiple connection processor 1i-52 that performs processing to operate in a multiple connection mode. The controller 1i-50 may control the overall operations of the base station to perform the method related to QoE measurement of the dual access UE described above.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, configuration information on a quality of experience (QoE) measurement, wherein the configuration information includes information indicating a signaling radio bearer (SRB) for transmitting a report of the QoE measurement according to the configuration information;
generating a QoE report by performing the QoE measurement based on the configuration information; and
transmitting the QoE report via the SRB based on the information.

2. The method of claim 1, wherein the SRB is configured for each QoE measurement configuration identity, and the QoE report is transmitted via the SRB for each QoE measurement configuration identity,
wherein the SRB is one of an SRB4 associated with a master base station or an SRB5 associated with a secondary base station,
wherein, in case that the information indicates the SRB4, the QoE report is transmitted to the master base station via the SRB4, and
wherein, in case that the information indicates the SRB5, the QoE report is transmitted to the secondary base station via the SRB5.

3. The method of claim 1, wherein, in case that the SRB is not available for the QoE report, the QoE report is stored in the UE.

4. The method of claim 1, further comprising:
transmitting, to the base station, a UE capability message including first information indicating whether the UE supports a QoE configuration in a new radio dual connectivity (NR-DC) and second information indicating whether the UE supports an SRB5 for QoE reporting.

5. The method of claim 1, wherein the SRB for transmitting the QoE report is negotiated between a master base station and a secondary base station.

6. A method performed by a base station in a wireless communication system, the method comprising:
transmitting, to a user equipment (UE), configuration information on a quality of experience (QoE) measurement, wherein the configuration information includes information indicating a signaling radio bearer (SRB) for receiving a report of the QoE measurement according to the configuration information; and
receiving, from the UE via the SRB, a QoE report including the QoE measurement based on the configuration information.

7. The method of claim 6, wherein the SRB is configured for each QoE measurement configuration identity, and the QoE report is received via the SRB for each QoE measurement configuration identity,
wherein the SRB is one of an SRB4 associated with a master base station or an SRB5 associated with a secondary base station,
wherein, in case that the information indicates the SRB4, the QoE report is received via the SRB4, and
wherein, in case that the information indicates the SRB5, the QoE report is received via the SRB5.

8. The method of claim 6, wherein, in case that the SRB is not available for the QoE report, the QoE report is stored in the UE.

9. The method of claim 6, further comprising:
receiving, from the UE, a UE capability message including first information indicating whether the UE supports a QoE configuration in a new radio dual connectivity (NR-DC) and second information indicating whether the UE supports an SRB5 for QoE reporting.

10. The method of claim 6, wherein the SRB for receiving the QoE report is negotiated between a master base station and a secondary base station.

11. A user equipment (UE) in a wireless communication system, the UE comprising:
a transceiver; and
a controller coupled with the transceiver and configured to:
receive, from a base station, configuration information on a quality of experience (QoE) measurement, wherein the configuration information includes information indicating a signaling radio bearer (SRB) for transmitting a report of the QoE measurement according to the configuration information,
generate a QoE report by performing the QoE measurement based on the configuration information, and
transmit the QoE report via the SRB based on the information.

12. The UE of claim 11, wherein the SRB is configured for each QoE measurement configuration identity, and the QoE report is transmitted via the SRB for each QoE measurement configuration identity,
wherein the SRB is one of an SRB4 associated with a master base station or an SRB5 associated with a secondary base station,
wherein, in case that the information indicates the SRB4, the QoE report is transmitted to the master base station via the SRB4, and
wherein, in case that the information indicates the SRB5, the QoE report is transmitted to the secondary base station via the SRB5.

13. The UE of claim 11, wherein, in case that the SRB is not available for the QoE report, the QoE report is stored in the UE.

14. The UE of claim 11, wherein the controller is further configured to:
transmit, to the base station, a UE capability message including first information indicating whether the UE supports a QoE configuration in a new radio dual connectivity (NR-DC) and second information indicating whether the UE supports an SRB5 for QoE reporting.

15. The UE of claim 11, wherein the SRB for transmitting the QoE report is negotiated between a master base station and a secondary base station.

16. A base station in a wireless communication system, the base station comprising:
a transceiver; and
a controller coupled with the transceiver and configured to:
transmit, to a user equipment (UE), configuration information on a quality of experience (QoE) measurement, wherein the configuration information includes information indicating a signaling radio bearer (SRB) for receiving a report of the QoE measurement according to the configuration information, and
receive, from the UE via the SRB, a QoE report including the QoE measurement based on the configuration information.

17. The base station of claim 16, wherein the SRB is configured for each QoE measurement configuration identity, and the QoE report is received via the SRB for each QoE measurement configuration identity,
wherein the SRB is one of an SRB4 associated with a master base station or an SRB5 associated with a secondary base station,
wherein, in case that the information indicates the SRB4, the QoE report is received via the SRB4, and
wherein, in case that the information indicates the SRB5, the QoE report is received via the SRB5.

18. The base station of claim 16, wherein, in case that the SRB is not available for the QoE report, the QoE report is stored in the UE.

19. The base station of claim 16, wherein the controller is further configured to:
receive, from the UE, a UE capability message including first information indicating whether the UE supports a QoE configuration in a new radio dual connectivity (NR-DC) and second information indicating whether the UE supports an SRB5 for QoE reporting.

20. The base station of claim 16, wherein the SRB for receiving the QoE report is negotiated between a master base station and a secondary base station.
